(19) United States
(12) Patent Application Publication
(10) Pub. No.: US 2026/0177865 A1
(43) Pub. Date: Jun. 25, 2026

(54) DISPLAY PANEL AND DISPLAY DEVICE

(71) Applicants: Beijing BOE Optoelectronics Technology Co., Ltd., Beijing (CN); BOE Technology Group Co., Ltd., Beijing (CN)

(72) Inventors: Lei SHI, Beijing (CN); Yashuai AN, Beijing (CN); Yong ZHANG, Beijing (CN); Hongjun YU, Beijing (CN); Yang GE, Beijing (CN); Xian WANG, Beijing (CN); Xingxing GUAN, Beijing (CN); Jianwei MA, Beijing (CN)

(21) Appl. No.: 18/711,633

(22) PCT Filed: Aug. 24, 2023
(86) PCT No.: PCT/CN2023/114770

§ 371 Date: May 20, 2024

(51) Int. Cl. G02F 1/1345

(52) U.S. Cl. CPC G02F 1/1345

(57) ABSTRACT

A display panel includes: a substrate, a driver chip located on the substrate and disposed in a bonding region. The driver chip includes a plurality of bonding pads. The display panel also includes a plurality of fanout traces located on the substrate. An end of each fanout trace is connected with a bonding pad and the other end of each fanout trace extends to a pixel region through a fanout region. The driver chip has a plurality of support regions disposed on a side of the part of the bonding pads close to the fanout region. The driver chip also includes redundant pads located in the support regions; a part of the fanout traces passes through an area between adjacent support regions, and a part of the fanout traces passes through the support regions and is disposed to be insulated from the redundant pads.

### CROSS-REFERENCE TO RELATED APPLICATION

The present application is a U.S. National Phase Entry of International Application No. PCT/CN2023/114770 having an international filing date of Aug. 24, 2023. Contents of the above-identified application should be interpreted as being incorporated into the present application by reference.

### TECHNICAL FIELD

The present disclosure pertains to the field of display technologies, and particularly to a display panel and a display device.

### BACKGROUND

With the continuous development of display technology, a display panel not only needs to achieve higher display quality, but also has higher requirements for other aspects of the display panel, one of which is the design of narrow bezels and equal width of four sides. The narrow bezels on the left and right sides of the display panel can be realized by Gate Driver on Array (GOA), and the gate signal lines in a pixel region can be opened row by row by combining thin film transistors. One of the ways to realize a lower bezel of the display panel is to adopt a sunken driver chip (Driver IC), which can effectively shorten the space occupied by a fanout trace between the pixel region and the driver chip. However, bonding pads of the sunken driver chip (mainly output pads for transmitting signals to the pixel region of the display panel) are arranged in an inclined direction, and there is a problem of poor attachment at upper left and upper right edge positions of the driver chip. Therefore, redundant pads are arranged in support regions of the upper left and upper right positions of the driver chip to ensure the tightness of attachment.

Because the redundant pads need to be placed in the support regions, in order to avoid short circuit between the fanout traces and the redundant pads, the fanout traces need to avoid the redundant pads in the support regions, and the fanout traces will be bent in the support regions to avoid short circuit caused by the connection between the fanout traces and the redundant pads in the support regions. This bending will increase a longitudinal tracing space, and then lead to the increase of the lower bezel, which will affect the display effect of the display panel.

### SUMMARY

The present disclosure aims at solving at least one of technical problems existing in the prior art, and provides a display panel and a display device.

In a first aspect, an embodiment of the present disclosure provides a display panel having a pixel region, a fanout region and a bonding region disposed at a side of the pixel region and sequentially arranged in a direction away from the pixel region. The display panel includes a substrate, a driver chip located on the substrate and disposed in the bonding region. The driver chip includes a plurality of bonding pads. The display panel further includes a plurality of fanout traces located on the substrate. An end of each of the fanout traces is connected with a bonding pad and the other end of each of the fanout traces extends to the pixel region through the fanout region.

A distance between a part of the bonding pads and a first edge of the driver chip gradually increases along a direction parallel to the first edge. The driver chip has a plurality of support regions disposed on a side of the part of the bonding pads close to the fanout region. The driver chip further includes redundant pads located in the support regions.

A part of the fanout traces passes through an area between adjacent support regions. A part of the fanout traces passes through the support regions and is disposed to be insulated from the redundant pads.

In an example, the redundant pads include a first insulation layer, a second insulation layer, a first transparent electrode layer located on the substrate and sequentially disposed in a direction away from the substrate.

The fanout traces include first sub-fanout traces. The first sub-fanout traces are located on a side of the substrate close to the first insulation layer.

In an example, the redundant pads further include a first metal layer located on a side of the substrate close to the first insulation layer.

The first metal layer includes a plurality of first metal strips arranged at intervals. The first sub-fanout traces are located between adjacent first metal strips.

In an example, the redundant pads further include a second metal layer between the first insulation layer and the second insulation layer.

The second metal layer coincides with the support regions.

In an example, the redundant pads further include a second metal layer between the first insulation layer and the second insulation layer.

The second metal layer is connected as an integral structure between adjacent support regions.

In an example, the redundant pads further include a second metal layer between the first insulation layer and the second insulation layer. The second metal layer includes a plurality of second metal strips disposed at intervals.

The fanout traces further include second sub-fanout traces. The second sub-fanout traces are located between adjacent second metal strips.

In an example, an orthographic projection of a first sub-fanout trace on the substrate is located between orthographic projections of adjacent second sub-fanout traces on the substrate.

An orthographic projection of a first metal strip on the substrate is located between orthographic projections of adjacent second metal strips on the substrate.

In an example, an orthographic projection of the first sub-fanout traces on the substrate coincides with an orthographic projection of the second sub-fanout traces on the substrate.

An orthographic projection of the first metal strips on the substrate coincides with an orthographic projection of the second metal strips on the substrate.

In an example, the length of the first metal strips and the length of the second metal strips along a direction parallel to the fanout traces are each equal to the length of the support regions along the direction parallel to the fanout traces.

In an example, an area of the first metal strips and an area of the second metal strips in each of the support regions are each greater than or equal to 70% of an area of the support region.

In an example, the redundant pads further include a second transparent electrode layer between the first insulation layer and the second insulation layer.

The second transparent electrode layer coincides with the support regions.

In an example, the redundant pads further include a second transparent electrode layer between the first insulation layer and the second insulation layer.

The second transparent electrode layer is connected as an integral structure between adjacent support regions.

In an example, the first transparent electrode layer coincides with the support regions.

In an example, the first transparent electrode layer is connected as an integral structure between adjacent support regions.

In an example, the first insulation layer and the second insulation layer are each connected as an integral structure between adjacent support regions.

In a second aspect, an embodiment of the present disclosure provides a display device. The display device includes the display panel provided as described above.

### BRIEF DESCRIPTION OF DRAWINGS

FIG. 1 is a schematic diagram of a structure of an exemplary display panel.

FIG. 2 is a schematic diagram of a structure of a driver chip in the display panel shown in FIG. 1.

FIG. 3 is a schematic diagram of a structure of another exemplary display panel.

FIG. 4 is a schematic diagram of a structure of a driver chip in the display panel shown in FIG. 3.

FIG. 5 is a schematic diagram of a structure of a display panel according to an embodiment of the present disclosure.

FIG. 6 is a schematic diagram of a first partial structure of redundant pads and fanout traces in the display panel shown in FIG. 5.

FIG. 7 is a schematic diagram of a cross-sectional structure of the structure shown in FIG. along an A-A′ direction.

FIG. 8 is a schematic diagram of a second partial structure of redundant pads and fanout traces in the display panel shown in FIG. 5.

FIG. 9 is a schematic diagram of a cross-sectional structure of the structure shown in FIG. along a B-B′ direction.

FIG. 10 is a schematic diagram of a third partial structure of redundant pads and fanout traces in the display panel shown in FIG. 5.

FIG. 11 is a schematic diagram of a cross-sectional structure of the structure shown in FIG. 10 along a C-C′ direction.

FIG. 12 is a schematic diagram of a fourth partial structure of redundant pads and fanout traces in the display panel shown in FIG. 5.

FIG. 13 is a schematic diagram of a cross-sectional structure of the structure shown in FIG. 12 along a D-D′ direction.

FIG. 14 is a schematic diagram of a fourth partial structure of redundant pads and fanout traces in the display panel shown in FIG. 5.

FIG. 15 is a schematic diagram of a cross-sectional structure of the structure shown in FIG. 14 along a E-E′ direction.

FIG. 16 is a schematic diagram of a fifth partial structure of redundant pads and fanout traces in the display panel shown in FIG. 5.

FIG. 17 is a schematic diagram of a cross-sectional structure of the structure shown in FIG. 16 along an F-F′ direction.

FIG. 18 is a schematic diagram of a sixth partial structure of redundant pads and fanout traces in the display panel shown in FIG. 5.

FIG. 19 is a schematic diagram of a cross-sectional structure of the structure shown in FIG. 18 in a G-G′ direction.

FIG. 20 is a schematic diagram of a seventh partial structure of redundant pads and fanout traces in the display panel shown in FIG. 5.

FIG. 21 is a schematic diagram of a cross-sectional structure of the structure shown in FIG. 20 in an H-H′ direction.

FIG. 22 is a schematic diagram of a seventh partial structure of redundant pads and fanout traces in the display panel shown in FIG. 5.

FIG. 23 is a schematic diagram of a cross-sectional structure of the structure shown in FIG. 22 along an I-I′ direction.

FIG. 24 is a schematic diagram of an eighth partial structure of redundant pads and fanout traces in the display panel shown in FIG. 5.

FIG. 25 is a schematic diagram of a cross-sectional structure of the structure shown in FIG. 24 along a J-J′ direction.

### DETAILED DESCRIPTION

To make those skilled in the art better understand technical solutions of the present disclosure, the present disclosure is described in further detail below with reference to the accompanying drawings and specific implementations.

Unless otherwise defined, technical terms or scientific terms used in the present disclosure should have the meanings as commonly understood by those of ordinary skills in the art to which the present disclosure pertains. The “first”, “second” and similar terms used in the present disclosure do not indicate any order, quantity, or importance, but are used only for distinguishing different components. Similarly, similar words such as “a”, “an” or “the” do not denote a limitation on quantity, but rather denote the presence of at least one. “Include”, “contain”, or similar words mean that elements or objects appearing before the words cover elements or objects listed after the words and their equivalents, but do not exclude other elements or objects. “Connect”, “couple”, or a similar words are not limited to a physical or mechanical connection, but may include an electrical connection, whether direct or indirect. “Upper”, “lower”, “left”, and “right”, etc., are used for representing a relative positional relationship, and when an absolute position of a described object is changed, the relative positional relationship may also be correspondingly changed.

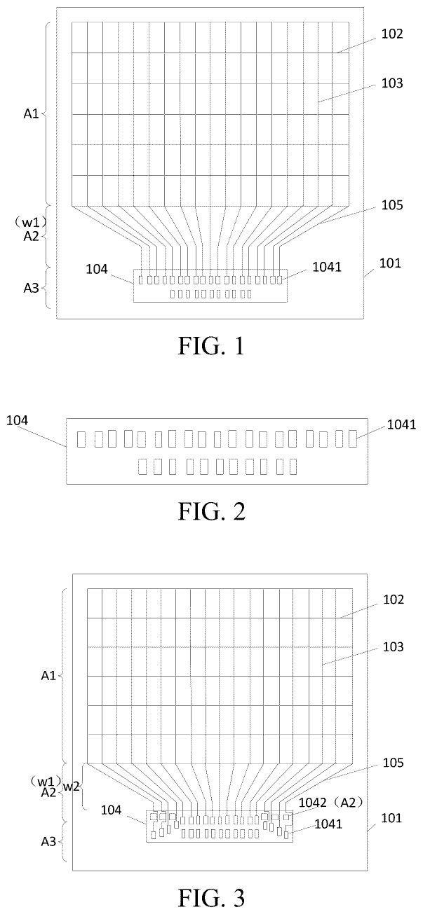

FIG. 1 is a schematic structural diagram of an exemplary display panel. The display panel has a pixel region A1, a fanout region A2 and a bonding region A3 disposed on a side of the pixel region A1 and sequentially disposed in a direction away from the pixel region A1 as shown in FIG. 1. The display panel includes a substrate 101, gate lines 102 on the substrate 101, data lines 103, a driver chip 104, and fanout traces 105.

The gate lines 102 and the data lines 103 are located in the pixel region A1 and are intersected. A plurality of pixel units (not shown in the figure) are formed in an area defined by the intersection of the gate lines 102 and the data lines 103. Each pixel unit is provided with a pixel circuit. The gate lines 102 and the data lines 103 are connected to the pixel circuit to control a drive signal input to the pixel circuit and realize a display function.

The driver chip 104 is located in the bonding region A3 and can provide a data signal for the data lines 103 in the pixel region A1. FIG. 2 is a schematic diagram of a structure of the driver chip in the display panel shown in FIG. 1. As shown in FIG. 2, the driver chip 104 includes a plurality of bonding pads 1041. The plurality of bonding pads 1041 are arranged in a direction parallel to a first edge of the driver chip 104. The first edge may be an output lead bump (OLB) side of the driver chip 104 which is an edge provided for most of output pads of the driver chip 104. Accordingly, the driver chip 104 also has a second edge, which is opposite to the first edge. The second edge may be an input lead bump (ILB) side of the driver chip 104, which is an edge provided by most of input pads of the driver chip 104.

One end of the fanout trace 105 is connected to the bonding pad 1041 (i.e. an output pad) and the other end of the fanout trace 105 is connected to the data line 103. The fanout traces 105 may extend through the fanout region A2 from the bonding region A3 to the display area A1 to transmit the drive signal provided by the driver chip 104 in the bonding region A3 to the data lines 103 in the pixel region A1. Generally speaking, due to layout design rules such as a line width and a line spacing of the fanout traces 105, the reduction of a width w1 of the fanout region A2 is limited, and based on the limitation of the width w1 of the fanout region A2, the reduction of a bezel width of the display panel is also limited, so it is impossible to realize the design of a narrow bezel and equal width on four sides.

Although the width w1 of the fanout region A2 cannot be further reduced, a distance between the driver chip 104 and the display region A1 can be reduced if the position of the driver chip 104 is further pushed toward the display region A1, which can facilitate the reduction of the bezel of the display panel.

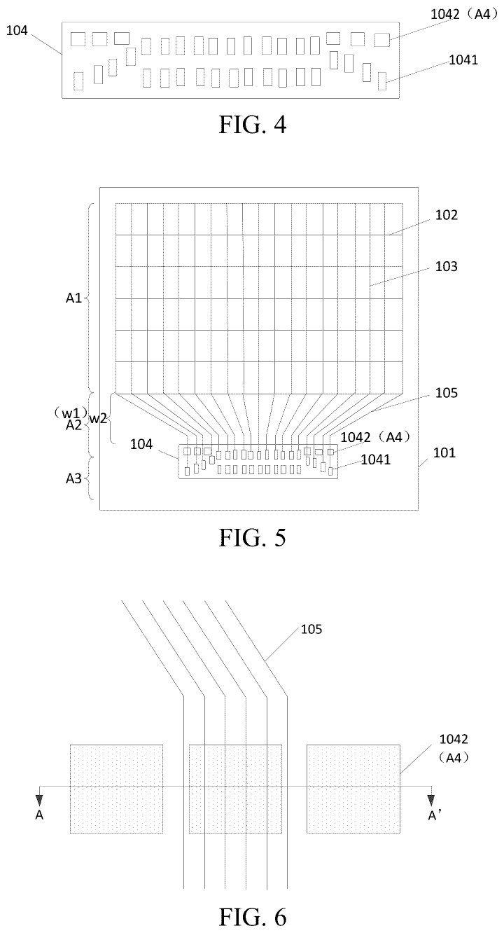

FIG. 3 is a schematic diagram of a structure of another exemplary display panel. The display panel has a pixel region A1, a fanout region A2 and a bonding region A3 arranged on a side of the pixel region A1 and sequentially disposed in a direction away from the pixel region A1 as shown in FIG. 3. The display panel includes a substrate 101 and a driver chip 104 located on the substrate 101 and disposed in the bonding region A3 (a structure in the pixel region A1 is the same as that in FIG. 1 described above and is not shown in FIG. 3). FIG. 4 is a schematic diagram of the structure of the driver chip in the display panel shown in FIG. 3. As shown in FIG. 4, the driver chip 104 includes a plurality of bonding pads 1041. The structure of the driver chip 104 is different from that of the driver chip 104 shown in FIG. 2 in that a part of the bonding pads 1041 is arranged in a direction parallel to a first edge of the driver chip 104, and a part of the bonding pads 1041 is not arranged in the direction of the first edge but has an included angle with the direction of the first edge and is arranged in an inclined direction. A distance between a part of the bonding pads 1041 and the first edge of the driver chip 104 gradually increases in the direction parallel to the first edge. Since a placement of a part of the bonding pads 1041 in the driver chip 104 appears to sink toward the fanout region A2 (as shown in FIG. 4), such a configuration of the driver chip 104 may be referred to as a “sunken driver chip”.

Since a part of the bonding pads 1041 in the driver chip 104 sinks toward the fanout region A2, the position of the driver chip 104 may be further advanced toward the fanout region A2 of the display panel such that a distance w2 between the driver chip 104 and the pixel region A1 of the display panel may be smaller than the width w1 of the fanout region A2. The reduction of the distance w2 between the driver chip 104 and the pixel region A1 of the display panel means that the bezel of the display panel can be further reduced.

However, since the bonding pads 1041 of the driver chip 104 (mainly output pads for transmitting signals to the pixel region of the display panel) are arranged in an inclined direction, there is a problem of poor attachment at upper left and upper right edge positions of the driver chip 104. Therefore, redundant pads 1042 are provided at support regions A4 at the upper left and upper right positions of the driver chip to ensure the tightness of attachment.

Due to the need to place redundant pads 1042 in the support regions A4, in order to avoid short circuit between the fanout traces 105 and the redundant pads 1042, the fanout traces 105 need to avoid the redundant pads 1042 in the support regions A4, and the fanout traces 105 will be bent in the support regions A4 to avoid short circuit caused by the connection between the fanout traces 105 and the redundant pads 1042 in the support regions A4. This bending will increase a longitudinal trace space, and then lead to the increase of a lower bezel, which will affect the display effect of the display panel.

In order to solve at least one of the above-mentioned technical problems, an embodiment of the present disclosure provides a display panel and a display device. The display panel and the display device provided by the embodiment of the present disclosure will be further described in detail with reference to the accompanying drawings and specific implementations.

In a first aspect, an embodiment of the present disclosure provides a display panel. FIG. 5 is a schematic diagram of a structure of the display panel provided by the embodiment of the present disclosure. As shown in FIG. 5, the display panel has a pixel region A1, a fanout region A2 and a bonding region A3 disposed on a side of the pixel region A1 and sequentially disposed along a direction away from the pixel region A1. The display panel includes a substrate 101, a driver chip 104 positioned on the substrate 101 and provided in the bonding region A3 (a structure in the pixel region A1 is the same as that in FIG. 1 described above). The driver chip 104 (the driver chip 104 has the same structure as the driver chip 104 shown in FIG. 4) includes a plurality of bonding pads 1041. The display panel further includes a plurality of fanout traces 105 on the substrate 101. An end of each of the fanout traces 105 is connected to a bonding pad 1041 and the other end of each of the fanout traces 105 extends to the pixel region A1 through the fanout region A2. A distance between a part of the bonding pads 1041 and a first edge of the driver chip 104 gradually increases in a direction parallel to the first edge. The driver chip 104 has a plurality of support regions A4 disposed on a side of the part of the bonding pads 1041 near the fanout region A2. The driver chip 104 also includes redundant pads 1042 located in the support regions A4. A part of the fanout traces 105 passes through an area between adjacent support regions A4, and a part of the fanout traces 105 passes through the support regions A4 and is disposed to be insulated from the redundant pads 1042.

The substrate 101 may be made of a rigid material such as glass, which can improve the load-bearing capacity of the substrate 101 to other film layers thereon. Alternatively, the substrate 101 may also be made of a flexible material such as polyimide (PI), which can improve the bending resistance and tensile resistance of the display substrate as a whole, and prevent the substrate 101 from breaking due to stress generated during bending, tensile and twisting, resulting in poor circuit opening. In a practical application, the material of the substrate 101 can be reasonably selected according to the actual needs, so as to ensure that the display substrate has good performance.

The driver chip 104 may be specifically a sunken driver chip (the structure of which may be as previously shown and will not be described in detail herein) and may provide a data signal to the data lines 103 in the pixel region A1. The bonding pads 1041 in the driver chip 104 may be specifically output pads which may be made of a metal material having good electrical conductivity, may form a single-layer structure made of a single material, or may form a multi-layer structure made of a plurality of different materials. The redundant pads 1042 in the driver chip 104 may be made of the same material as the bonding pads 1041 and formed in the same structure as the bonding pads 1041 so that the redundant pads 1042 and the bonding pads 1041 have approximately the same thickness, ensuring a good support effect, thereby ensuring the tightness of attachment.

The fanout traces 105 may serve as connection lines between the data lines 103 and the driver chip 104 for transmitting data signals. The fanout traces 105 may be made of a metal material, such as one of molybdenum (Mo), aluminum (Al), titanium (Ti), or an alloy of a plurality of the above-mentioned materials, which may have a single-layer structure or a multi-layer structure.

In the display panel provided by the embodiment of the present disclosure, a part of the fanout traces 105 passes through an area between adjacent support regions A4, and a part of the fanout traces 105 passes through the support regions A4, and is disposed to be insulated from the redundant pads 1042. In this way, the fanout traces 105 at the positions of the support regions A4 do not need to adopt a trace in a bending manner, thereby avoiding increasing the longitudinal trace space. Therefore, the width of the lower bezel of the display panel can be reduced, and the design of narrow bezel and equal width on four sides can be realized, thus facilitating the improvement of the display effect of the display panel.

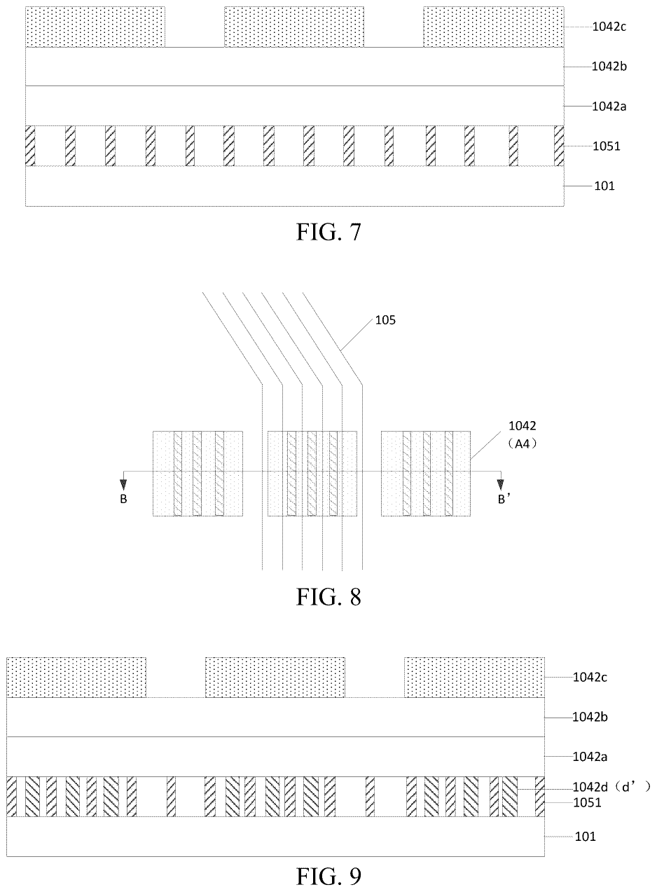

FIG. 6 is a schematic diagram of a first partial structure of redundant pads and fanout traces in the display panel shown in FIG. 5, and FIG. 7 is a schematic diagram of a cross-sectional structure of the structure shown in FIG. 6 along an A-A′ direction. As shown in FIGS. 6 and 7, the redundant pads 1042 include a first insulation layer 1042a, a second insulation layer 1042b, and a first transparent electrode layer 1042c which are located on the substrate 101 and are sequentially disposed in a direction away from the substrate 101. The fanout traces 105 include first sub-fanout traces 1051 which are located on a side of the substrate 101 close to the first insulation layer 1042a.

The first insulation layer 1042a and the second insulation layer 1042b may be made of at least one of silicon nitride (SiN), silicon oxide (SiO2) which can form a single-layer structure made of a single material or a multi-layer structure made of a plurality of different materials. In a practical application, only one of the first insulation layer 1042a and the second insulation layer 1042b may be provided in order to achieve an insulating effect, but two insulation layers, i.e. the first insulation layer 1042a and the second insulation layer 1042b, are generally provided in order to ensure the overall thickness of the redundant pads 104 in the support regions A4. Specifically, the first insulation layer 1042a may be provided in the same layer as a gate insulation layer (not shown in the figure) covering a gate of the pixel region A1 in the display panel, and the second insulation layer 1042b may be provided in the same layer as an interlayer insulation layer on a side of a interlayer insulation layer covering a source-drain electrode layer (not shown in the figure) of a thin film transistor of the pixel region A1 in the display panel. In the fabrication process, the first insulation layer 1042a in the redundant pads 1042 may be formed with the same material and the same process as the gate insulation layer in the pixel region A1, and the second insulation layer 1042b may be formed with the same material and the same process as the interlayer insulation layer in the pixel region A1, thus reducing the process steps and saving the fabrication cost.

The first transparent electrode layer 1042c may be made of a transparent conductive material such as indium tin oxide (ITO). Specifically, the first transparent electrode layer 1042c may be disposed in the same layer as a pixel electrode (not shown in the figure) of the pixel region A1 in the display panel. In the preparation process, the first transparent electrode layer 1042c may be formed using the same material and the same process as the pixel electrode of the pixel region A1, which can reduce the process steps and save the preparation cost.

The fanout traces 105 may adopt a single-layer structure including first sub-fanout traces 1051. The first sub-fanout traces 1051 may be disposed on a side of the substrate 101 near the first insulation layer 1042a. In this way, the first sub-fanout traces 1051 are disposed to be insulated from other conductive layers (e.g., the first transparent electrode layer 1042c) in the redundant pads 1041 via the first insulation layer 1042a and the second insulation layer 1042b, and short circuit may be avoided due to the connection between the first sub-fanout traces 1051 and the first transparent electrode layer 1042c. Therefore, the first sub-fanout traces 1051 can directly pass through the support regions A4, and the first sub-fanout traces 1051 do not need to adopt a trace in a bending manner, thus avoiding increasing the longitudinal trace space, which can reduce the width of the lower bezel of the display panel and realize the design of narrow bezel and equal width on four sides, thereby facilitating the improvement of the display effect of the display panel.

FIG. 8 is a schematic diagram of a second partial structure of the redundant pads and the fanout traces in the display panel shown in FIG. 5, and FIG. 9 is a schematic diagram of a cross-sectional structure of the structure shown in FIG. 8 along a B-B′ direction. The structure as shown in FIGS. 8 and 9 is different from the structure shown in FIGS. 6 and 7 in that the redundant pads 1042 further include a first metal layer 1042d located on a side of the substrate 101 near the first insulation layer 1042a. The first metal layer 1042d includes a plurality of first metal strips 1042d′ arranged at intervals, and the first sub-fanout traces 1051 are located between adjacent first metal strips 1042d′.

The first metal layer 1042d may be made of a metal material having good conductivity, such as one of molybdenum (Mo), aluminum (Al), titanium (Ti), or an alloy of a plurality of the aforementioned materials, and may be a single-layer structure or a multi-layer structure. In the embodiment of the present application, the first metal layer 1042d is a single-layer structure. The first metal layer 1042d is divided into a plurality of first metal strips 1042d′ disposed at intervals in each support region A4, and the fanout traces 105 may be a single-layer structure including a first sub-fanout traces 1051. The first sub-fanout traces 1051 may pass through a gap between adjacent first metal strips 1042d′. In this way, the first sub-fanout traces 1051 are disposed to be disconnected from the first metal layer 1042d and disposed to be insulated from other conductive layers (e.g., the first transparent electrode layer 1042c) in the redundant pads 1041 through the first insulation layer 1042a and the second insulation layer 1042b, thereby avoiding short circuit caused by the connection between the first sub-fanout traces 1051 and the first transparent electrode layer 1042c and the first metal layer 1042d. Therefore, the first sub-fanout traces 1051 can directly pass through the support regions A4, and the first sub-fanout traces 1051 do not need to adopt a trace in a bending manner, thus avoiding increasing the longitudinal trace space, which can reduce the width of the lower bezel of the display panel and realize the design of narrow bezel and equal width on four sides, thereby facilitating the improvement of the display effect of the display panel. Furthermore, the first metal strips 1042d′ can increase the support area to ensure the overall support effect of the redundant pads 1042.

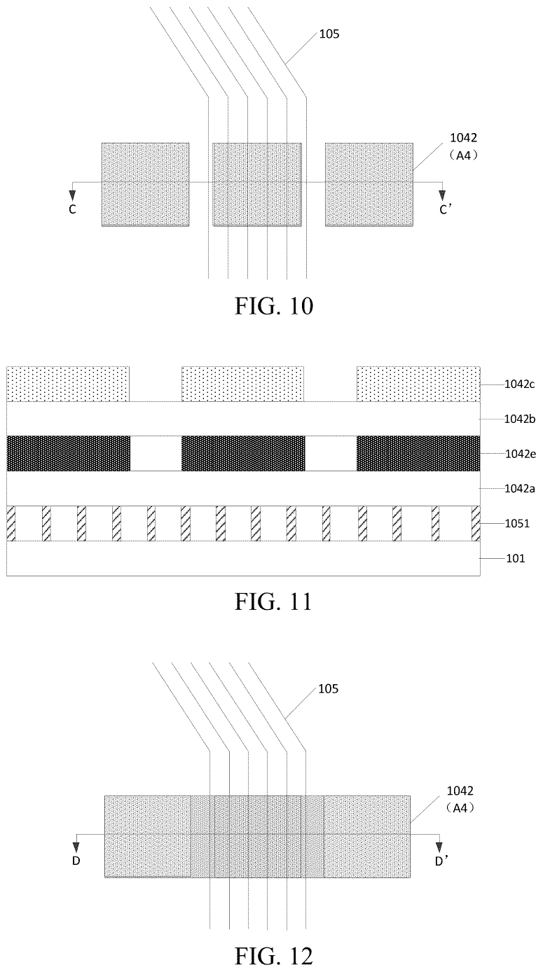

FIG. 10 is a schematic diagram of a third partial structure of the redundant pads and the fanout traces in the display panel shown in FIG. 5, and FIG. 11 is a schematic diagram of a cross-sectional structure of the structure shown in FIG. 10 in a C-C′ direction. The structure shown in FIGS. 10 and 11 is different from the structure shown in FIGS. 6 and 7 in that the redundant pads 1042 further include a second metal layer 1042e between the first insulation layer 1042a and the second insulation layer 1042b, and the second metal layer 1042e overlaps with the support regions A4.

The second metal layer 1042e may be made of a metal material having good conductivity, such as one of molybdenum (Mo), aluminum (Al), titanium (Ti), or an alloy of a plurality of the aforementioned materials, and may be a single-layer structure or a multi-layer structure. In the embodiment of the present application, the second metal layer 1042e is a single-layer structure. The second metal layer 1042e covers the entire support regions A2 which may further increase the overall support effect of the redundant pads 1042.

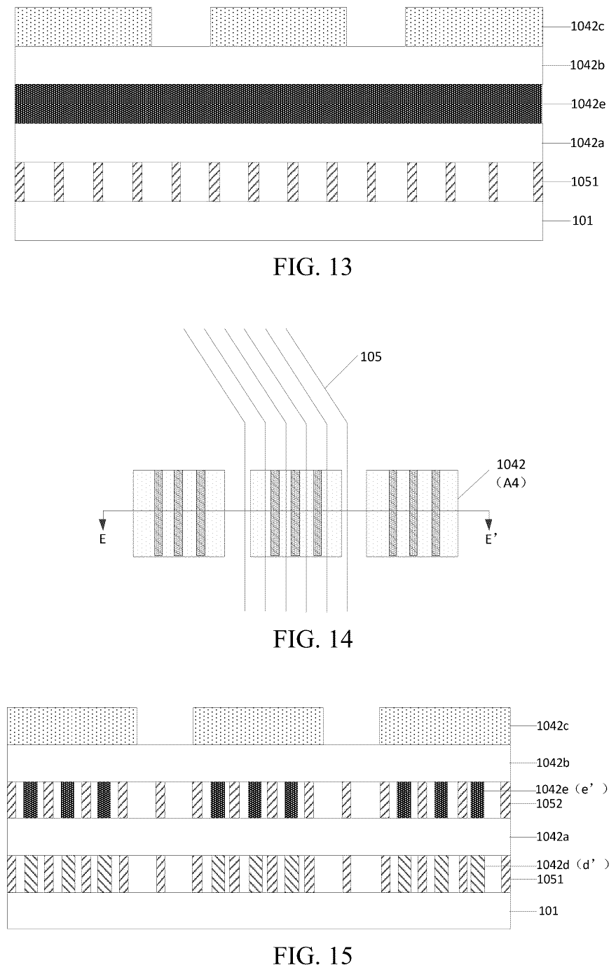

FIG. 12 is a schematic diagram of a fourth partial structure of the redundant pads and the fanout traces in the display panel shown in FIG. 5, and FIG. 13 is a schematic diagram of a cross-sectional structure of the structure shown in FIG. 12 along a D-D′ direction. The structure shown in FIGS. 12 and 13 is different from the structure shown in FIGS. 10 and 11 in that the redundant pads 1042 further include a second metal layer 1042e between the first insulation layer 1042a and the second insulation layer 1042b, and the second metal layer 1042e is connected as an integral structure between adjacent support regions A4.

In the embodiment of the present application, the second metal layer 1042e is a single-layer structure. The second metal layer 1042e is connected as an integral structure between adjacent support regions A4, which can further increase the overall support effect of the redundant pads 1042.

FIG. 14 is a schematic diagram of a forth partial structure of the redundant pads and the fanout traces in the display panel shown in FIG. 5, and FIG. 15 is a schematic diagram of a cross-sectional structure of the structure shown in FIG. 14 along an E-E′ direction. The structure shown in FIGS. 14 and 15 is different from the structure shown in FIGS. 12 and 13 in that the redundant pads 1042 further include a second metal layer 1042e between the first insulation layer 1042a and the second insulation layer 1042b, the second metal layer 1042e includes a plurality of second metal strips 1042e′ arranged at intervals, the fanout traces 105 further include second sub-fanout traces 1052, and the second sub-fanout traces 1052 are located between adjacent second metal strips 1042e′.

In the structure shown in FIGS. 14 and 15, the fanout traces 105 adopt a double layer structure including first sub-fanout traces 1051 and second sub-fanout traces 1052. The first metal layer 1042d is a single-layer structure and the second metal layer 1042e is a single-layer structure. In each support region A4, the first metal layer 1042d is divided into a plurality of first metal strips 1042d′ disposed at intervals and the second metal layer 1042e is divided into a plurality of second metal strips 1042e′ disposed at intervals. The first sub-fanout traces 1051 may pass through a gap between adjacent first metal strips 1042d′, and the second sub-fanout traces 1052 may pass through a gap between adjacent second metal strips 1042e′. In this way, the first sub-fanout traces 1051 are disposed to be disconnected from the first metal layer 1042d, and the second sub-fanout traces 1052 are disposed to be disconnected from the second metal layer 1042e, and are disposed to be insulated from other conductive layers (e.g., the first transparent electrode layer 1042c) in the redundant pads 1041 through the first insulation layer 1042a and the second insulation layer 1042b, thereby avoiding short circuit caused by the connection between the first sub-fanout traces 1051, the second sub-fanout traces 1052 and the first transparent electrode layer 1042c, the first metal layer 1042d, and the second metal layer 1042d. Therefore, the first sub-fanout traces 1051 and the second sub-fanout traces 1052 can directly pass through the support regions A4, and the first sub-fanout traces 1051 and the second sub-fanout traces 1052 do not need to adopt a trace in a bending manner, thus avoiding increasing the longitudinal trace space, which can reduce the width of the lower bezel of the display panel and realize the design of narrow bezel and equal width on four sides, thereby facilitating the improvement of the display effect of the display panel.

In some embodiments, as shown in FIG. 15, an orthographic projection of a first sub-fanout trace 1051 on the substrate 101 is located between orthographic projections of adjacent second sub-fanout traces 1052 on the substrate 101. An orthographic projection of a first metal strip 1042d′ on the substrate 101 is located between orthographic projections of adjacent second metal strips 1042e′ on the substrate 101.

The first sub-fanout traces 1051 and the second sub-fanout traces 1052 are staggered, so that a distance between them can be increased, and large parasitic capacitance can be avoided between them when transmitting driving signals, thus ensuring the stability of drive signal transmission. Accordingly, the first metal strips 1042d′ and the second metal strips 1042e′ are also staggered.

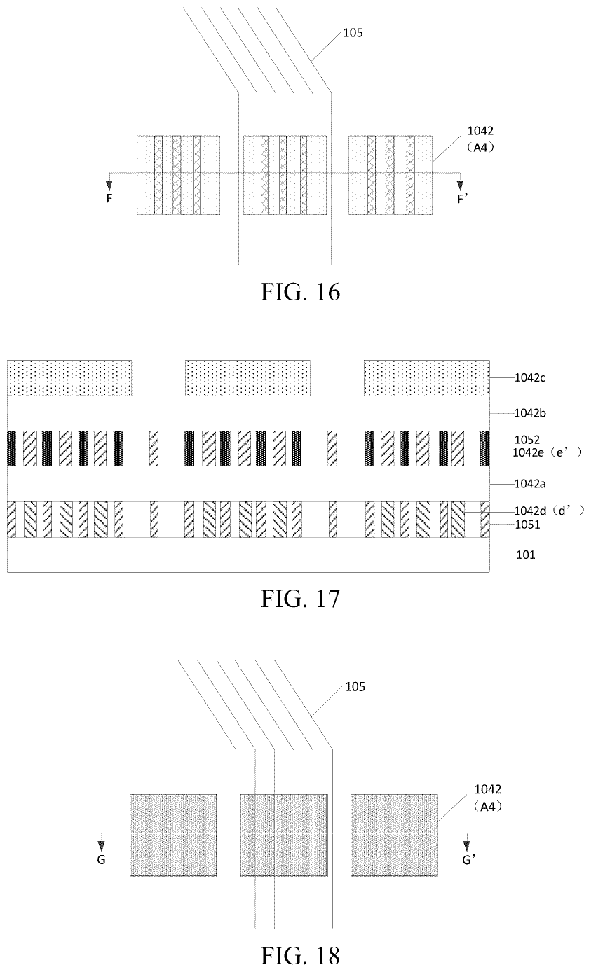

FIG. 16 is a schematic diagram of a fifth partial structure of the redundant pads and fanout traces in the display panel shown in FIG. 5, and FIG. 17 is a schematic diagram of a cross-sectional structure of the structure shown in FIG. 16 along a F-F′ direction. The structure is different from the structure shown in FIGS. 14 and 15 in that an orthographic projection of the first sub-fanout traces 1051 on the substrate 101 coincides with an orthographic projection of the second sub-fanout traces 1052 on the substrate 101, and an orthographic projection of the first metal strips 1042d′ on the substrate 101 coincides with an orthographic projection of the second metal strips 1042e′ on the substrate 101.

The first sub-fanout traces 1051 and the second sub-fanout traces 1052 are arranged opposite to each other, which can reduce the preparation difficulty and save the preparation cost in the preparation process. Accordingly, the first metal strips 1042d′ and the second metal strips 1042e′ are also disposed opposite to each other.

In some embodiments, the length of the first metal strips 1042d′ and the length of the second metal strips 1042e′ in a direction parallel to the fanout traces 105 are each equal to the length of the support regions A4 in the direction parallel to the fanout traces 105. The area of the first metal strips 1042d′ and the area of the second metal strips 1042e′ in each support region A4 are each greater than or equal to 70% of the area of the support region A4. In this way, the first metal strips 1042d′ and the second metal strips 1042e′ can have a good support effect.

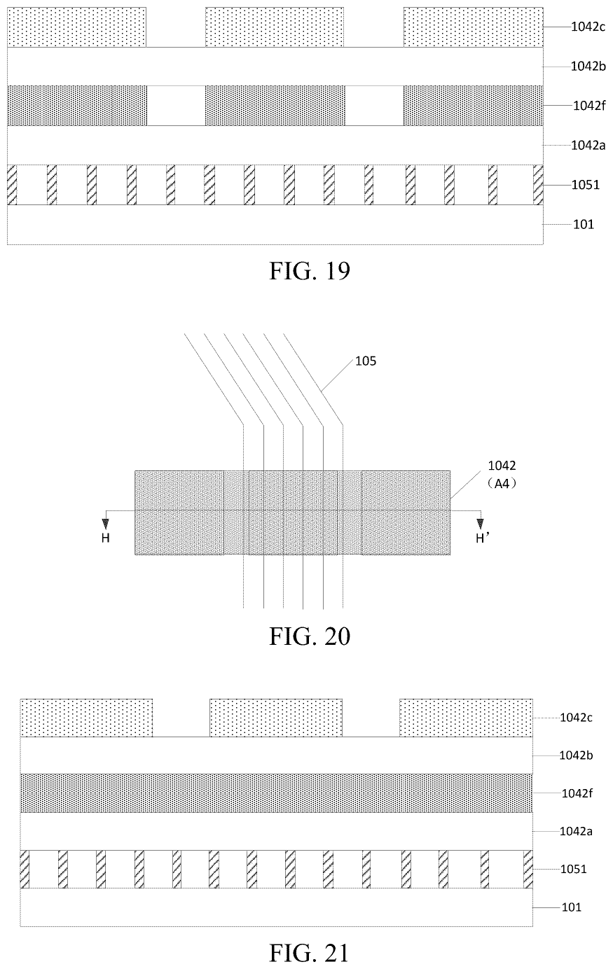

In some embodiments, FIG. 18 is a schematic diagram of a sixth partial structure of the redundant pads and fanout traces in the display panel shown in FIG. 5, and FIG. 19 is a schematic diagram of a cross-sectional structure of the structure shown in FIG. 18 in a G-G′ direction. The structure shown in FIGS. 18 and 19 is different from the structure shown in FIGS. 10 and 11 in that the redundant pads 1042 further include a second transparent electrode layer 1042f between the first insulation layer 1042a and the second insulation layer 1042b, and the second transparent electrode layer 1042f overlaps with the support regions A4.

The second transparent electrode layer 1042f can replace the second metal layer 1042e and also play a supporting role. And the thickness of the second transparent electrode layer 1042f can be controlled to ensure the support effect.

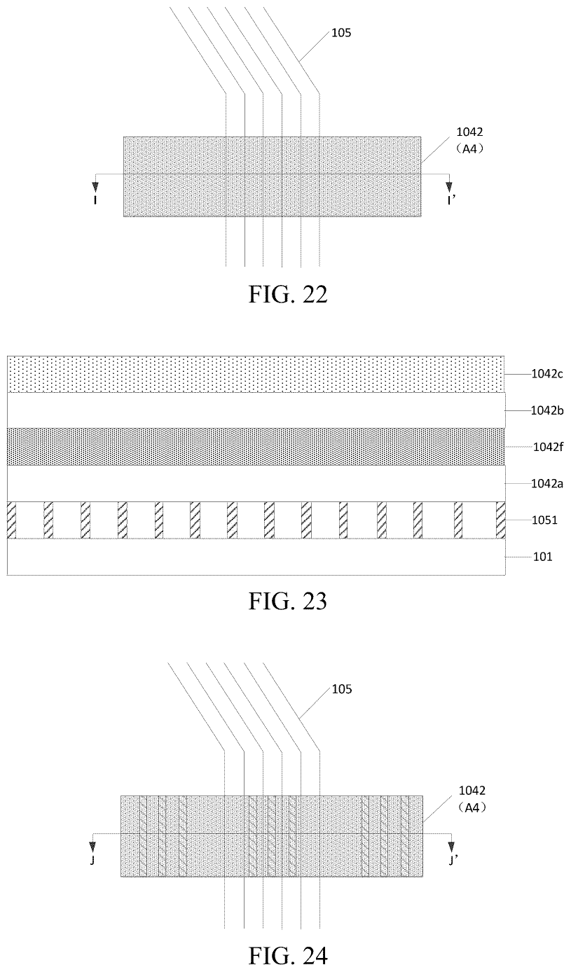

In some embodiments, FIG. 20 is a schematic diagram of a seventh partial structure of the redundant pads and fanout traces in the display panel shown in FIG. 5, and FIG. 21 is a schematic diagram of a cross-sectional structure of the structure shown in FIG. 20 along a H-H′ direction. The structure shown in FIGS. 20 and 21 is different from the structure shown in FIGS. 18 and 19 in that the redundant pads 1042 further include a second transparent electrode layer 1042f between the first insulation layer 1042a and the second insulation layer 1042b, and the second transparent electrode layer 1042f is connected as an integral structure between adjacent support regions A4.

The second transparent electrode layer 1042f is connected as an integral structure between adjacent support regions A4, which can increase the support area and ensure the overall support effect of the redundant pads 1042.

In some embodiments, the first transparent electrode layer 1042c coincides with the support regions A4 as shown above in FIGS. 6-21.

The first transparent electrode layer 1042c may cover only each of the support regions 1042, thereby reducing the process difficulty and saving the preparation cost during the preparation process.

In some embodiments, FIG. 22 is schematic diagram of a seventh partial structure of the redundant pads and fanout traces in the display panel shown in FIG. 5, and FIG. 23 is a schematic diagram of a cross-sectional structure of the structure shown in FIG. 22 along an I-I′ direction. The structure shown in FIGS. 22 and 23 is different from the aforementioned structures of FIGS. 6 to 21 in that the first transparent electrode layer 1042c is connected as an integral structure between adjacent support regions A4.

The first transparent electrode layer 1042c is connected as an integral structure between adjacent support regions A4, which can increase the support area and ensure the overall support effect of the redundant pads 1042.

In some embodiments as shown in FIGS. 6 to 23, the first insulation layer 1042a and the second insulation layer 1042b are each connected as an integral structure between adjacent support regions A4.

The first insulation layer 1042a and the second insulation layer 1042b are each connected as an integral structure between adjacent support regions A4, which can increase the support region and ensure the overall support effect of the redundant pad 1042.

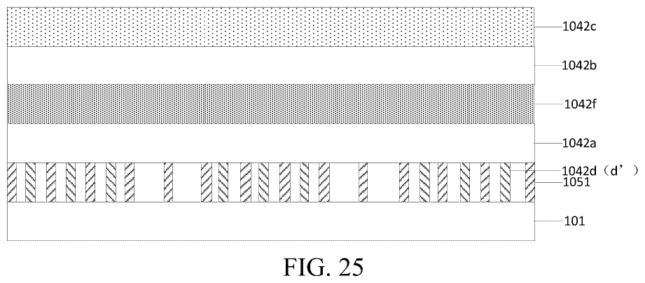

In some embodiments, FIG. 24 is a schematic diagram of an eighth partial structure of the redundant pads and fanout traces in the display panel shown in FIG. 5, and FIG. 25 is a schematic diagram of a cross-sectional structure of the structure shown in FIG. 24 along a J-J′ direction. The structure shown in FIGS. 24 and 25 is different from the aforementioned structure of FIGS. 22 to 23 in that the redundant pads 1042 further include a first metal layer 1042d located on a side of the substrate 101 close to the first insulation layer 1042a, the first metal layer 1042d includes a plurality of first metal strips 1042d′ disposed at intervals, and the first sub-fanout traces 1051 are located between adjacent first metal strips 1042d′. The first metal strips 1042d′ can increase the support area and ensure the overall support effect of the redundant pads 1042.

In a second aspect, an embodiment of the present disclosure provides a display device, which includes the display panel as provided in any of the aforementioned embodiments. The display device may be any product or component with a display function, such as a television, a mobile phone, a display, a laptop computer, a digital photo bezel, or a navigator. Its implementation principle is similar to that of the display panel described above, and will not be repeated here.

It is to be understood that the above embodiments are only exemplary embodiments employed for the purpose of illustrating the principles of the present disclosure, however the present disclosure is not limited thereto. To those of ordinary skills in the art, various modifications and improvements may be made without departing from the essence and substance of the present disclosure, and these modifications and improvements are also considered to be within the scope of the present disclosure.

1. A display panel having a pixel region, a fanout region and a bonding region disposed at a side of the pixel region and sequentially disposed in a direction away from the pixel region; wherein the display panel comprises a substrate, a driver chip located on the substrate and disposed in the bonding region; the driver chip comprises a plurality of bonding pads; the display panel further comprises a plurality of fanout traces located on the substrate; an end of each of the fanout traces is connected with a bonding pad and the other end of each of the fanout traces extends to the pixel region through the fanout region;
a distance between a part of the bonding pads and a first edge of the driver chip gradually increases along a direction parallel to the first edge; the driver chip has a plurality of support regions disposed on a side of the part of the bonding pads close to the fanout region; the driver chip further comprises redundant pads located in the support regions;
a part of the fanout traces passes through an area between adjacent support regions; a part of the fanout traces passes through the support regions and is disposed to be insulated from the redundant pads.

2. The display panel according to claim 1, wherein the redundant pads comprise:
a first insulation layer, a second insulation layer, and a first transparent electrode layer located on the substrate and sequentially disposed in a direction away from the substrate;
the fanout traces comprise first sub-fanout traces; the first sub-fanout traces are located on a side of the substrate close to the first insulation layer.

3. The display panel according to claim 2, wherein the redundant pads further comprise a first metal layer located on a side of the substrate close to the first insulation layer;
the first metal layer comprises a plurality of first metal strips arranged at intervals; the first sub-fanout traces are located between adjacent first metal strips.

4. The display panel according to claim 3, wherein the redundant pads further comprise: a second metal layer between the first insulation layer and the second insulation layer;
the second metal layer coincides with the support regions.

5. The display panel according to claim 3, wherein the redundant pads further comprise: a second metal layer between the first insulation layer and the second insulation layer;
the second metal layer is connected as an integral structure between the adjacent support regions.

6. The display panel according to claim 3, wherein the redundant pads further comprise: a second metal layer between the first insulation layer and the second insulation layer; the second metal layer comprises a plurality of second metal strips disposed at intervals;
the fanout traces further comprise: second sub-fanout traces; the second sub-fanout traces are located between adjacent second metal strips.

7. The display panel according to claim 6, wherein an orthographic projection of a first sub-fanout trace on the substrate is located between orthographic projections of adjacent second sub-fanout traces on the substrate;
an orthographic projection of a first metal strip on the substrate is located between orthographic projections of adjacent second metal strips on the substrate.

8. The display panel according to claim 6, wherein an orthographic projection of the first sub-fanout traces on the substrate coincides with an orthographic projection of the second sub-fanout traces on the substrate;
an orthographic projection of the first metal strips on the substrate coincides with an orthographic projection of the second metal strips on the substrate.

9. The display panel according to claim 6, wherein the length of the first metal strips and the length of the second metal strips along a direction parallel to the fanout traces are each equal to the length of the support regions along the direction parallel to the fanout traces.

10. The display panel according to claim 6, wherein an area of the first metal strips and an area of the second metal strips in each of the support regions are each greater than or equal to 70% of an area of the support region.

11. The display panel according to claim 3, wherein the redundant pads further comprise: a second transparent electrode layer between the first insulation layer and the second insulation layer;
the second transparent electrode layer coincides with the support regions.

12. The display panel according to claim 3, wherein the redundant pads further comprise: a second transparent electrode layer between the first insulation layer and the second insulation layer;
the second transparent electrode layer is connected as an integral structure between the adjacent support regions.

13. The display panel according to claim 2, wherein the first transparent electrode layer coincides with the support regions.

14. The display panel according to claim 2, wherein the first transparent electrode layer is connected as an integral structure between the adjacent support regions.

15. The display panel according to claim 2, wherein the first insulation layer and the second insulation layer are each connected as an integral structure between the adjacent support regions.

16. A display device, wherein the display device comprises the display panel of claim 1.

17. The display panel according to claim 2, wherein the first insulation layer and the second insulation layer are made of at least one of silicon nitride and silicon oxide.

18. The display panel according to claim 2, wherein the first transparent electrode layer is made of a transparent conductive material.

19. The display panel according to claim 6, wherein the first sub-fanout traces and the second sub-fanout traces are staggered, and the first metal strips and the second metal strips are also staggered.

20. The display panel according to claim 6, wherein the first sub-fanout traces and the second sub-fanout traces are arranged opposite to each other, and the first metal strips and the second metal strips are also disposed opposite to each other.
